(19) United States
(12) Patent Application Publication
(10) Pub. No.: US 2012/0059696 A1
(43) Pub. Date: Mar. 8, 2012

(54) SYSTEMS AND METHODS FOR PROVIDING ADVERTISEMENTS TO USER DEVICES USING AN ADVERTISEMENT GATEWAY

(75) Inventors: James Theberge, Santa Clara, CA (US); Devon Earl Brian Boyle, San Francisco, CA (US); Ram Senthamarai, San Jose, CA (US); Mohan Rao Pindyala, Santa Clara, CA (US); Sivakumar Chandrasekharan, Pleasanton, CA (US)

(73) Assignee: UNITED VIDEO PROPERTIES, INC., Santa Clara, CA (US)

(21) Appl. No.: 13/227,245

(22) Filed: Sep. 7, 2011

Related U.S. Application Data
(60) Provisional application No. 61/381,008, filed on Sep. 8, 2010.

(51) Int. Cl. G06Q 30/02

(52) U.S. Cl. 705/14.4

(57) ABSTRACT

An advertisement gateway that provides an interface for multiple user devices and multiple advertisement sources to communicate is presented. The advertisement gateway is capable of translating advertisement requests from a user device in a particular format into another format that is compatible with an advertisement source. Conversely, the advertisement gateway can translate advertisement responses from an advertisement source in a particular format into another format that is compatible with the requesting device. In this manner, the advertisers only have to develop an advertisement using a single protocol and format (i.e., the protocol to communicate with the advertisement source) and still be able to provide their advertisements to a wide variety of user devices.

### CROSS REFERENCE TO RELATED APPLICATION

This application claims the benefit of U.S. Provisional Application No. 61/381,008, filed Sep. 8, 2010, the disclosure of which is hereby incorporated by reference herein in its entirety.

### FIELD OF THE DISCLOSURE

The present disclosure relates to an advertisement gateway that interfaces user devices with multiple advertisement sources.

### BACKGROUND OF THE DISCLOSURE

Advertising is an important marketing tool for advertisers to deliver promotional content to consumers. Significant new avenues for marketing have emerged with the recent and rapid expansion of highly capable internet-enabled user entertainment devices, such as tablet computers, smartphones, gaming consoles, set-top boxes, Blu-ray players, DVD players, and televisions. Generally, advertisers would like to be able to advertise on as many of these different devices as possible. However, these devices are developed by different manufactures, and as such, have developed different protocols and formats for advertisement communication and display. Accordingly, an advertiser has to develop different versions of an advertisement and build in support for each of the devices on which they would like to advertise, each being compatible with the different device protocols.

### SUMMARY OF THE DISCLOSURE

As noted above, currently advertisers have to develop a different version of an advertisement for each device they wish to advertise on in order to be compatible with the protocol and format of each individual device. Developing different versions of an advertisement can be costly, time consuming, and cumbersome for advertisers. This disclosure presents an advertisement gateway that can interface with various devices and various advertisement sources. In particular, the advertisement gateway is capable of translating advertisement requests from a device in a particular format into another format that is compatible with an advertisement source. Conversely, the advertisement gateway can translate advertisement responses from an advertisement source in a particular format into another format that is compatible with the requesting device. In this manner, the advertisers only have to develop an advertisement using a single protocol and format (i.e., the protocol to communicate with the advertisement source) and still be able to provide their advertisements to a wide variety of user devices. Thus, the advertisement gateway expands an advertiser's advertisement placement options while reducing the advertiser's burden to develop many different versions of an advertisement.

This disclosure provides illustrative embodiments of methods and systems for providing advertisements to user devices. The disclosed methods and systems utilize an advertisement gateway to interface between multiple user devices and multiple advertisements sources such that they can communicate even when using different protocols.

In some embodiments, the systems for providing advertisements to user devices include control circuitry at, for example, an advertisement gateway that is configured to receive an advertisement request from a user device in a first format that is compatible with the user device. In some embodiments, after receiving the advertisement request, an advertisement source is selected from multiple advertisement sources to process the advertisement request. In some embodiments, there is only one advertisement source or a default advertisement source; as such, no source selection may be necessary. After determining what source is to process the advertisement request, the advertisement request is translated into a second format that is compatible with the advertisement source that was selected to process the request. In some embodiments, no translation is necessary because the first format is compatible with the selected advertisement source.

Once the translating is complete, the translated advertisement request is transmitted to the advertisement source for processing. After processing the request, the advertisement source sends an advertisement response back to the advertisement gateway. The advertisement response generally includes information regarding what advertisement was selected by the advertisement source. For example, the response may include server information as to where the user device may retrieve the selected advertisement. When the advertisement response is received at the advertisement gateway, the response is translated into a format that is compatible with the user device that sent the initial advertisement request. In some embodiments, the response is not translated when the response is transmitted by the advertisement source already in a format that is compatible with the user device. After translating the response, the advertisement gateway transmits the response to the user device so that the user device can display the requested advertisement to a user.

In some embodiments, when there are multiple advertisement sources to choose from, the advertisement gateway selects one of the advertisement sources based on routing rules. The routing rules may be based on the inventory characteristics of the advertisement sources, priority designations associated with the advertisement sources, and/or various advertisement campaigns.

In some embodiments, the advertisement gateway determines whether the response received from the advertisement source is an empty response. For example, an empty response may be a response that does not include any advertisement parameters or a timed out response. In some embodiments, when a response is determined to be an empty response, the advertisement gateway determines whether another advertisement source is available to process the advertisement request. If another source is available, the gateway selects the other source. In some embodiments, the selection of the other source is also based on routing rules, but to the exclusion of the source that previously provided the empty response.

In some embodiments, a weight associated with the advertisement source that provided the empty response may be adjusted so that that advertisement source is less likely to be selected to process subsequent advertisement requests. For example, if an advertisement source is unable to fulfill an advertisement request, it may be prudent to substantially exclude that source from future requests so that advertisement request/response latency is substantially minimized. After the other source is selected, the advertisement gateway translates the request into a format compatible with the other source and transmits the translated request to the other advertisement source.

In some embodiments, the advertisement gateway transmits a default response after determining that the response received from the advertisement source was an empty response. A default response generally includes default advertisement parameters. The requests and responses may be in one of the following formats: Representational State Transfer (REST), Services-Oriented Access Protocol (SOAP), JavaScript Object Notation (JSON), or Extensible Markup Language (XML).

These and other important aspects of the present disclosure are described more fully in the detailed description below.

### BRIEF DESCRIPTION OF THE DRAWINGS

The above and other objects and advantages of the present disclosure will be apparent upon consideration of the following detailed description, taken in conjunction with the accompanying drawings, in which like reference characters refer to like parts throughout, and in which:

FIG. 1 shows an illustrative system that includes an advertisement gateway in accordance with some embodiments of the present disclosure;

FIG. 2 shows advertisement gateway circuitry that may be used in an implementation of the advertisement gateway in FIG. 1 in accordance with some embodiments of the present disclosure;

FIG. 3 shows an illustrative grid program listings display arranged by time and channel that also enables access to different types of media content in a single display in accordance with some embodiments of the present disclosure;

FIG. 4 shows an illustrative microsite having various promotional features in accordance with some embodiments of the present disclosure;

FIG. 5 shows an illustrative data structure of a request for an advertisement in accordance with some embodiments of the present disclosure;

FIG. 6 shows an illustrative data structure of a response to a request for an advertisement in accordance with some embodiments of the present disclosure;

FIG. 7 shows an illustrative flow chart of an exemplary process for processing a request for an advertisement in accordance with some embodiments of the present disclosure;

FIG. 8 shows another illustrative flow chart of an exemplary process for processing a request for an advertisement in accordance with some embodiments of the present disclosure;

FIG. 9 shows an illustrative flow chart of an exemplary process for processing a request for an advertisement in accordance with some embodiments of the present disclosure; and

FIG. 10 shows another illustrative flow chart of an exemplary process for processing a request for an advertisement in accordance with some embodiments of the present disclosure.

### DETAILED DESCRIPTION OF THE DISCLOSURE

To provide an overall understanding of the disclosed methods and systems, certain illustrative embodiments will now be described, including systems and methods for using an advertisement gateway to interface communications between multiple user devices and multiple advertisement sources. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

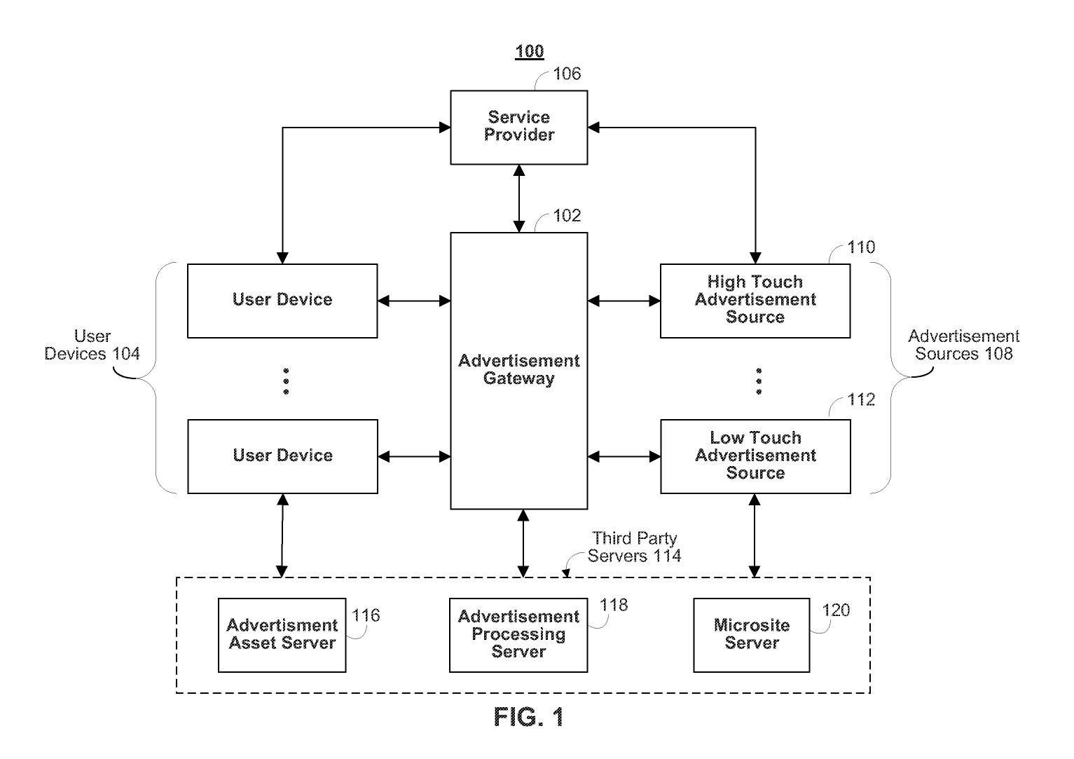

FIG. 1 shows an illustrative system that includes an advertisement gateway in accordance with some embodiments of the present disclosure. System 100 includes advertisement gateway 102, user devices 104, service provider 106, advertisement sources 108, and third party servers 114.

User devices 104 include multiple user devices. The user devices can be any suitable type of device that is capable of presenting media content. For example, user devices 104 may include personal computers, laptops, tablet computers, mobile telephones, smartphones, music players, gaming consoles, set-top boxes, Blu-ray players, DVD players, and televisions. In some instances, some of user devices 104 include applications that can be downloaded and/or installed in user devices 104. For example, the application can be an application capable of providing interactive advertisements. User devices 104 can be portable or non-portable and communicate with other elements in system 100 using wired and/or wireless means. For example, one of user devices 104 can be a portable smartphone with wireless internet capabilities that can communicate with advertisement gateway 102 over the Internet.

Herein, media content may refer to any suitable type of media, including, but not limited to, conventional television programming (e.g., provided via traditional broadcast, cable, satellite, Internet, or other means), pay-per-view programs, on-demand programs (e.g., video-on-demand (VOD) programs), Internet content (e.g., streaming media, downloadable media, Webcasts, etc.), video clips, articles, advertisements, chat sessions, games, still images, animation, text, interactive media, and other types of audio, visual and/or media content. Media content may be recorded, played, displayed, provided, and/or accessed by information content processing devices, such as user devices 104. In some embodiments, media content may also be part of a live performance.

Advertisement sources 108 include multiple advertisement sources that can provide various advertisements to user devices 104, advertisement gateway 102, service provider 106, and/or third party servers 114. For example, one of advertisement sources 108 can receive an advertisement request from one of user devices 104 via advertisement gateway 102. Once the advertisement request is received, the advertisement source selects a suitable advertisement for the requesting device and transmits the selected advertisement and/or information regarding the selected advertisement to the requesting device via advertisement gateway 102. An advertisement source may be individual advertisement server that can provide advertisements or an advertisement network that aggregates advertisements from multiple advertisement servers.

An advertisement may be any suitable text, image, video, and/or audio that draws a viewer's attention to the particular product(s) and/or service(s) that are being advertised. Generally, advertisers pay a media or service provider for the opportunity to present their advertisement(s) to viewers. Generally advertisements present promotional information regarding products or services provided by or associated with the advertiser. The advertisements may be interactive, targeted according to the viewer's interests, and/or modified according to the viewer's interests.

An image may be any type of visual content including a graphic, a picture, a chart, etc. Video may be any type of video content including a promotional video advertisement, video clip, movie, trailer, animation, etc. Audio may be any type of audio content including promotional dialogue, songs, narration, background music, sound effects, synthesized speed, etc. Text may be any sequence of characters including messages (e.g., email or SMS), titles, indicators, identifiers, hyperlinks, names, addresses, phone numbers, etc.

Advertisement sources 108 may include high touch advertisement source 110 and/or low touch advertisement source 112. High touch advertisement source 110 provides high touch advertisements which may generally be complex advertisements that involve some degree of human interaction (e.g., an interactive advertisement). For example, a high touch advertisement for a mobile device application may include large, high quality graphical images, video, audio, and be interactive. Low touch advertisement source 112 provides low touch advertisements which may generally be less complex advertisements than the high touch advertisements. For example, a low touch advertisement for a mobile device application may be a small advertisement that simply includes text and low quality images. In some embodiments, a high touch advertisement versus a low touch advertisement may refer to their value based upon cost per mille (CPM), cost per impression (CPI), cost per click through (CPC), cost per time (CPT), or any other suitable advertisement valuation metric. For example, an advertisement with a relatively high CPM (e.g., a relatively high value advertisement) may be considered to be a high touch advertisement, while an advertisement with a relatively low CPM (e.g., a relatively low value advertisement) may be considered to be a low touch advertisement.

Usually, high touch advertisements are higher value advertisements than low touch advertisements because the high touch advertisements are generally more effective for promotional purposes. For example, a service provider may charge an advertiser more to provide a high touch advertisement to a device versus a low touch advertisement. In some embodiments, an advertisement source can provide both high touch and low touch advertisements. There may be more than one of each of high touch advertisement source 110 and low touch advertisement source 112, but only one of each is shown in FIG. 1 to avoid overcomplicating the drawing.

Advertisement gateway 102 provides a standard interface for advertisement requests from and responses to various user devices and applications. For example, advertisement gateway 102 receives advertisement requests from user devices 104 using a particular type of format and protocol. The request for advertisements from user devices 104 may be generated by a media guidance application, a widget (e.g., an application comprising portable code intended for more than one software platform), a web browser, a mobile application, or any suitable software or hardware of user devices 104. For example, when a user accesses a particular menu in a mobile application, the menu may include an area reserved for advertisement placement. After Advertisement gateway 102 receives the request, advertisement gateway 102 then selects one of advertisement sources 108 to provide the requested advertisement. In some embodiments, advertisement gateway 102 may incorporate any number of different advertisement sources or swap out any number of expired advertisement sources from its list of available advertisement sources for selection. In some embodiments, the selection of the advertisement source to provide the requested advertisement is based on routing rules. Such advertisement source selection and routing rules will be discussed in greater detail below.

After the advertisement source has been selected, advertisement gateway 102 converts the advertisement request to a format that is compatible with the selected advertisement source and transmits the request using a protocol that is compatible with the selected advertisement source. When the selected advertisement source receives the request, the advertisement source selects an appropriate advertisement according to the parameters defined by the advertisement request. In some embodiments, the advertisement source selects the appropriate advertisement using an advertising auction among various advertisers in addition to the parameters defined by the advertisement request. An advertising auction provides a medium for advertisers to bid on advertisement space within media programming.

Systems and methods for bid-based delivery of advertising promotions are discussed in greater detail in connection with Patterson et al., U.S. Patent Application Publication No. 2007-0038514 (Attorney Docket No. UV-598), published Feb. 15, 2007, which is hereby incorporated by reference herein in its entirety. In some embodiments, the advertisement is additionally or alternatively selected based on the capabilities of the requesting device (e.g., hardware or software of the device) or the device type. For example, advertisements with high resolutions may be selected for devices with greater processing capabilities. As another example, an advertisement developed for mobile devices may be selected over other advertisements when the requesting device is a mobile device. Once the advertisement is selected by the advertisement source, the source transmits it to advertisement gateway 102 in the form of an advertisement response using a format and protocol of the selected advertisement source's choosing.

When advertisement gateway 102 receives the advertisement response, gateway 102 converts the advertisement response to a format that is compatible with the requesting device and transmits the converted response to the device. After receiving the advertisement response, the requesting device processes the response and displays the advertisement in the area reserved for advertisement placement.

Advertisement gateway 102 may be a stand-alone system or may be incorporated into user devices 104 and/or advertisement sources 108. In some embodiments, advertisement gateway 102 may be, include, or be part of an application, a software module, or any other suitable set of computer-readable instructions. For example, advertisement gateway 102 may be a software application that is installed or downloaded, for instance, in user device 104. In some embodiments, advertisement gateway 102 may run as an application on user device 104, one of advertisement sources 108, and/or service provider 106.

A widget is an application (i.e., a collection of instructions executable by a processor). In some embodiments, a widget provides a user with access to a frequently used feature. For example, a widget may be configured to allow a user with a subscription to Netflix to access media content available from Netflix on their television. In addition, a widget may provide information from the Internet and/or otherwise remotely accessible servers (hereinafter “remote servers”) to a user. A widget may provide this information through web services and/or using any suitable communication protocol (e.g., TCP/IP, IPTV, etc.). Widgets may also perform local processing tasks, such as modifying media elements and video frames of an advertisement, and may also control display features of user devices 104, such as hardware and software tasks involved in displaying a video frame of an advertisement.

A widget may run on a television, user device associated with a television, and/or other user device capable of providing media to a user (e.g., a mobile phone, e-reader, camera, or video player). Television widgets are widgets that run strictly on the hardware platform (e.g., control circuitry) of a television.

Typically, television widgets have limited interactions with external user device and databases, such as set-top boxes and third party servers. It will be understood that where the below description refers to a widget or widgets, the term is inclusive of television widgets and other applications with widget-type functionality. For example, a widget may be or include a JAVA applet executable on a mobile device. JAVA is a trademark owned by Sun Microsystems, Inc. More generally, a widget may be, include, or be part of an application, a software module, or other suitable set of computer-readable instructions. A widget may also be referred to, in some instances, as an “app.”

A media guidance application provides an interface that allows users to efficiently navigate through media selections and easily identify media content that they may desire. Media guidance applications may take various forms depending on the media for which they provide guidance. One typical type of media guidance application is an interactive television guide. Interactive television program guides (sometimes referred to as electronic program guides or EPGs) are well-known guidance applications that, among other things, allow users to navigate among and locate many types of media content including conventional television programming (provided via traditional broadcast, cable, satellite, the Internet, or other means), as well as pay-per-view (PPV), on-demand programs (as in video-on-demand systems), Internet content (e.g., streaming media, downloadable media, Webcasts, etc.), recorded programs and other types of media content (e.g., audio content). Moreover, media guidance applications allow users to navigate among and locate content related to the media content for which guidance is provided including, for example, video clips, audio assets, articles, advertisements, chat sessions, games, etc. Media guidance application may be provided as on-line applications (i.e., provided on a web-site), or as stand-alone applications or clients.

In some embodiments, advertisement responses are transmitted from advertisement sources 108 with the advertisement assets associated with the selected advertisement (e.g., the images, audio, and/or video that are part of the advertisement). In some embodiments, the advertisement assets are provided by advertisement asset server 116. In some embodiments, the advertisement response includes information from where user devices 104 and advertisement gateway 102 may retrieve the media assets. For example, media assets for an advertisement may be stored in one of third party servers 114. When advertisement gateway 102 receives an advertisement response that is not accompanied with media assets, gateway 102 contacts the appropriate third party server 114 to retrieve the media assets. For example, the advertisement response may include server information on where to obtain the graphics for the advertisement.

After advertisement gateway 102 retrieves the media assets, gateway 102 forwards the assets to the appropriate user device 104 with the advertisement response for display. In some embodiments, user devices 104 retrieve the media assets after receiving an advertisement response that is not accompanied with media assets. The costs associated with graphic processing can be reduced by offloading the graphic processing to advertisement processing server 118 in this manner.

Third party servers 114 includes advertisement asset server 116, advertisement processing server 118, and microsite server 120. In some embodiments, third party servers 114 includes audit servers (not shown) that may be used in monitoring actions taken by users and user devices, as well as storing information regarding the monitored actions.

Advertisement asset server 116 may include any suitable computer server equipment capable of providing advertisement assets, such as images, videos, text, or audio, or any combination thereof for inclusion in advertisements provided to user devices 104. Advertisement asset server 116 may include a database for storing the advertisement assets or may fetch the advertisement assets from other servers and/or databases. Advertisement asset server 116 may deliver the advertisement assets over a communications network directly to user devices 104 or indirectly through advertisement gateway 102. Advertisement asset server 116 may be an Internet server such as that belonging to a website of an advertiser. In some embodiments, advertisement asset server 116 may be configured to fetch an advertisement graphic in response receiving a request from user device 104.

Advertisement processing server 118 may include processing circuitry capable of processing advertisement assets, such as those from advertisement asset server 116. Processing may include image processing, video processing, audio processing, and/or any other sort of content manipulation. The processing features of advertisement processing server 118 may be implemented in hardware, software, or both. Processing an advertisement asset may include extracting a portion of the advertisement asset (e.g., using facial recognition technology), altering the geometrical properties of the advertisement asset, adjusting the color properties of the advertisement asset, adjusting the resolution and/or quality of the advertisement asset, applying a filter (e.g., a blur filter) to the advertisement asset, adding shadow and/or highlight features to the advertisement asset, converting the advertisement asset from one format to another (e.g., from a JPEG to a Device Independent Bitmap), or a combination thereof. Alternatively, processing may include incorporating additional content into an existing advertisement asset (e.g., overlaying an advertiser's logo over an existing video or image).

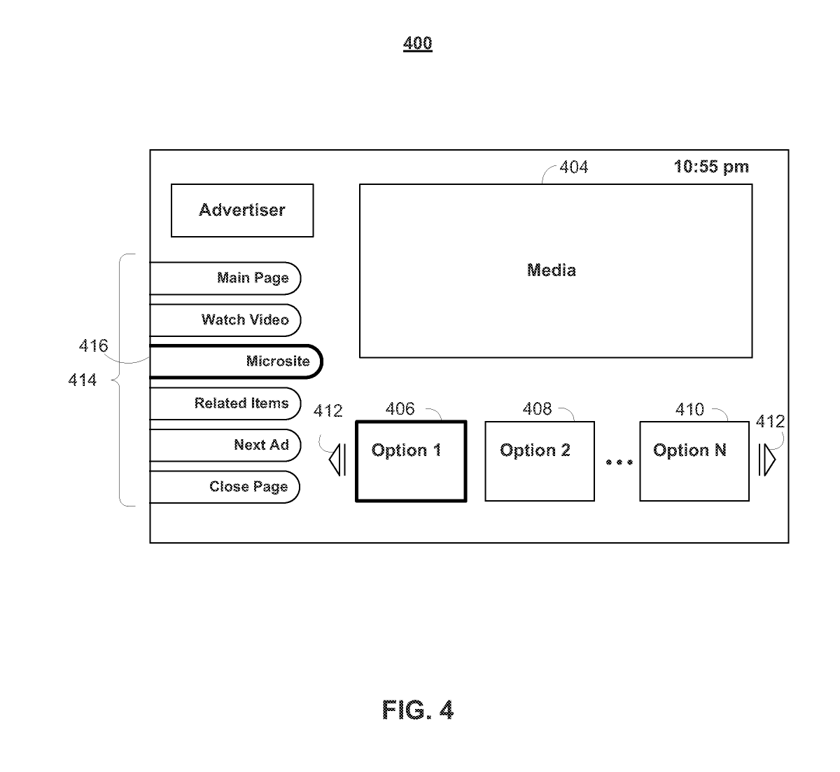

Microsite server 120 may function as an auxiliary supplement for an advertisement. In particular, microsite server 120 may be a website, sometimes referred to as a “microsite,” that displays promotional content associated with a particular advertiser. An illustrative example of a microsite is shown and discussed below in connection with FIG. 4. Microsite server 120 may also monitor user actions that occur when a user is presented with a microsite. The user actions may include, without limitation, a user selection of watch, record, or remind functionalities that are presented on the microsite. Alternatively, microsite server 120 may also monitor any events of interest to an advertiser. Microsite server 120 may store reports (“microsite reports”) based upon its monitoring of various actions on the microsite. In some embodiments, advertisement gateway 102 may request the microsite reports from microsite server 120 in order to determine media consumption habits of a user.

Service provider 106 may include one or more types of media distribution equipment including a television distribution facility, cable system head-end, satellite distribution facility, programming sources (e.g., television broadcasters, such as NBC, ABC, HBO, etc.), intermediate distribution facilities and/or servers, Internet providers, on-demand media servers and other media content providers. NBC is a trademark owned by the National Broadcasting Company, Inc., ABC is a trademark owned by the ABC, INC. and HBO is a trademark owned by the Home Box Office, Inc.

Service provider 106 may be the originator of media content, e.g., a television or Internet broadcaster, a Webcast or streaming video provider, a digital cable service provider, a bundled communication (e.g., the Internet, telephone and TV) provider such as Verizon FiOS, a provider of digital on-demand media, a cellular telephone service provider, etc. Alternatively, service provider 106 may not be the originator of media content, e.g., an on-demand media content provider, an Internet provider of video content of broadcast programs for downloading or streaming, etc. Service provider 106 may include cable sources, satellite providers, on-demand providers, Internet providers, or other providers of media content. Service provider 106 may also include a remote media server used to store different types of media content (e.g., an advertisement graphic), in a location remote from advertisement gateway 102 and user device 104.

As used herein, the term broadcaster may refer to an analog or digital signal provider, a cable network, a satellite provider, an Internet website, an Internet content provider, or any such provider that may distribute media content such as video assets to user devices 104. As used herein, the terms broadcaster's website or media broadcaster's website may refer to one or many web addresses, server addresses, databases, or other sources of media information or media content, specific to a particular broadcaster and associated with Internet websites or other content providers. Systems and methods for remote storage of media content and providing remotely stored media content to user device are discussed in greater detail in connection with Ellis et al., U.S. Pat. No. 7,761,892, issued Jul. 20, 2010, which is hereby incorporated by reference herein in its entirety.

The elements illustrated by FIG. 1 may be capable of communicating with one another using any suitable communication means. For example, communications between the elements in FIG. 1 may utilize a local area network, a wide area network, the Internet, a mobile device network, cable network, public switched telephone network, or other types of communications networks, a satellite path, a fiber-optic path, a cable path, a path that supports Internet communications (e.g., IPTV), free-space connections (e.g., for broadcast or other wireless signals), or any other suitable wired or wireless communications path or combination of such paths. Additionally, the elements in system 100 may communicate directly with each other through a communications network and/or via short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a trademark owned by Bluetooth SIG, INC. The user device devices may also communicate with each other indirectly, e.g., through an indirect path via a communications network. Communications may be provided by one or more of these communications paths, but are shown as single paths in

FIG. 1 to avoid overcomplicating the drawing.

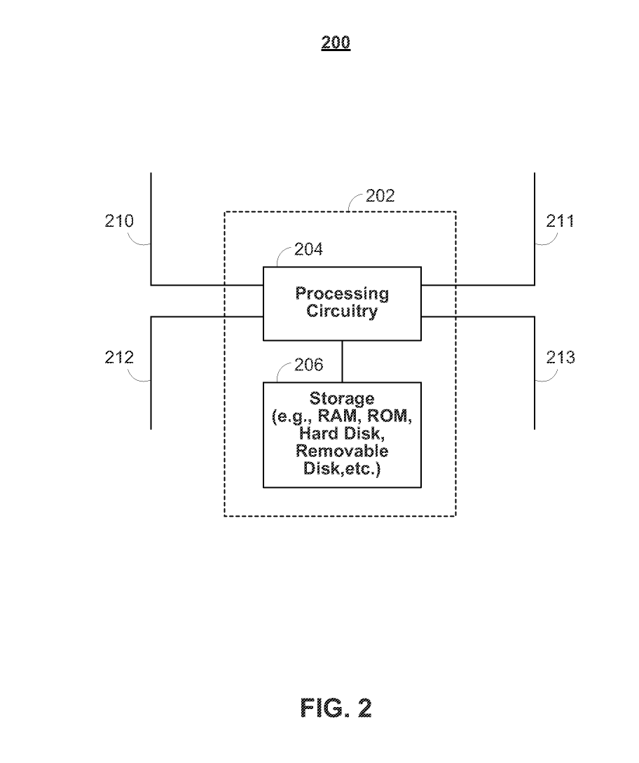

FIG. 2 shows illustrative advertisement gateway circuitry 200 that may be used in an implementation of advertisement gateway 102 of FIG. 1 in accordance with some embodiments of the present disclosure. Circuitry 200 may include control circuitry 202, which may include processing circuitry 204 and storage 206. Circuitry 200 may be substantially the same as, or may be comprised within, advertisement gateway 102 of FIG. 1. Control circuitry 202 may be coupled to a communications network. Accordingly, control circuitry 202 may communicate with each of user device 104, advertisement sources 108, service provider 106, and third party servers 114 of FIG. 1 via a communications network using communications paths 210, 211, 212, and 213, respectively. Communications paths 210-213 may be coupled directly or indirectly to the same communications network as control circuitry 202. Advertisement gateway functions (e.g., streaming web-based interactive advertisements) may be provided via one or more of the communications paths.

Control circuitry 202 may include any suitable processing circuitry based on one or more microprocessors, microcontrollers, digital signal processors, programmable logic devices, etc. In some embodiments, control circuitry 202 executes instructions for advertisement gateway 102 of FIG. 1 and/or other applications stored in storage 206. Control circuitry 202 may include communications circuitry suitable for communicating with any number and type of networks, servers, or devices. Communications circuitry may include a cable modem, fiber optic modem, an integrated services digital network (ISDN) modem, a digital subscriber line (DSL) modem, a telephone modem, or a wireless modem for communications with other equipment. Such communications may involve the Internet or any other suitable communications networks or paths (described above in more detail in connection with FIG. 1).

Processing circuitry 204 may also include image/video generating and processing circuitry, such as one or more digital compression, decompression, encoding and decoding circuitry, or any other suitable media generating and processing circuits, or combinations of such circuits. Encoding circuitry may be used to convert analog or digital signals to encoded signals (e.g., signals encoded in MPEG-2 or MPEG-4 formats) for storage. Decoding circuitry may be used to decode encoded signals to analog or digital signals that are suitable for display on a display device. For example, processing circuitry 204 may include an MPEG-2 encoder for encoding a video advertisement retrieved from a third party server (e.g., advertisement asset server 116 of FIG. 1). Processing circuitry 204 may also include scaler circuitry for upconverting and downconverting images or videos into the preferred output format for processing by user device (e.g., user device 104 of FIG. 1). Processing circuitry 204 may also include digital-to-analog converter circuitry and analog-to-digital converter circuitry for converting between digital and analog signals. The circuitry described herein, including for example, the video generating, compression, decompression, encoding, decoding, scaler, and analog/digital circuitry, may be implemented using any suitable hardware or software running on one or more general purpose and/or specialized processors.

Storage 206 may be memory (e.g., random-access memory, read-only memory, or any other suitable memory), flash memory, hard drives, optical drives, or any other suitable fixed or removable storage devices (e.g., DVD recorder, CD recorder, video cassette recorder, or other suitable recording device). Storage 206 may include one or more of the above types of storage devices. For example, control circuitry 202 may include a hard drive for storing memory-intensive advertisements (e.g., video advertisements) and flash memory for storing advertisement-related images (e.g., images that were captured using a digital camera). Storage 206 may be used to store various types of media and data described herein, including advertisement information, a list of advertisement sources, user preferences or profile information, media elements, video assets, or other data may be used in operating control circuitry 202. Nonvolatile memory may also be used (e.g., to launch a boot-up routine and other instructions).

In some embodiments, circuitry 200 may identify media consumption habits of a user by using processing circuitry 204. For example, advertisement or media consumption habits of a user may be determined from a microsite report retrieved from a microsite server (e.g., microsite server 120 of FIG. 1). The determined media consumption habits of the user may then be used to select an advertisement source from a plurality of advertisement sources (e.g., advertisement sources 108 of FIG. 1). More specifically, media consumption habits may be incorporated into advertisement routing rules that circuitry 200 uses in selecting an advertisement source, the details of which will discussed further below.

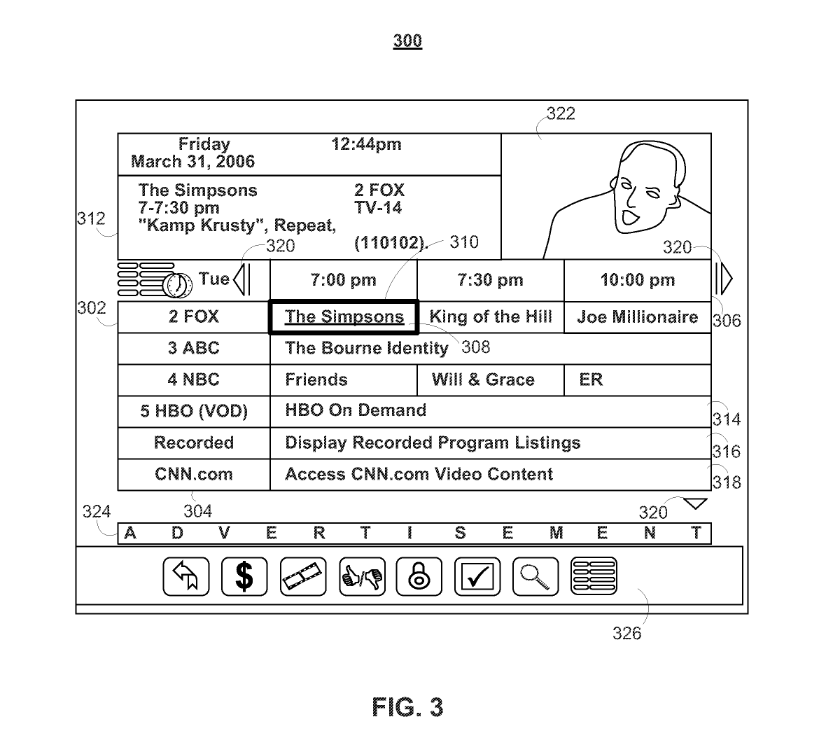

FIG. 3 shows illustrative grid program listings display 300 arranged by time and channel that also enables access to different types of media content in a single display. Display 300 may include grid 302 with: (1) a column of channel/media type identifiers 304, where each channel/media type identifier (which is a cell in the column) identifies a different channel or media type available; and (2) a row of time identifiers 306, where each time identifier (which is a cell in the row) identifies a time block of programming. Grid 302 also includes cells of program listings, such as program listing 308, where each listing provides the title of the program provided on the listing's associated channel and time. With a user input device, a user can select program listings by moving highlight region 310. Information relating to the program listing selected by highlight region 310 may be provided in program information region 312. Region 312 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet website (e.g., HULU or YOUTUBE) or other Internet access (e.g., FTP).

Grid 302 may provide listings for non-linear programming including on-demand listing 314, recorded media listing 316, and Internet content listing 318. A display combining listings for content from different types of media sources is sometimes referred to as a “mixed-media” display. The various permutations of the types of listings that may be displayed that are different than display 300 may be based on user selection or guidance application definition (e.g., a display of only recorded and broadcast listings, only on-demand and broadcast listings, etc.). As illustrated, listings 314, 316, and 318 are shown as spanning the entire time block displayed in grid 302 to indicate that selection of these listings may provide access to a display dedicated to on-demand listings, recorded listings, or Internet listings, respectively. In other embodiments, listings for these media types may be included directly in grid 302. Additional listings may be displayed in response to the user selecting one of the navigational icons 320. (Pressing an arrow key on a user input device may affect the display in a similar manner as selecting navigational icons 320.)

Display 300 may also include video region 322, advertisement 324, and options region 326. Video region 322 may allow the user to view and/or preview programs that are currently available, will be available, or were available to the user. The content of video region 322 may correspond to, or be independent from, one of the listings displayed in grid 302. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 324 may provide an advertisement for media content that, depending on a viewer's access rights (e.g., for subscription programming), is currently available for viewing, will be available for viewing in the future, or may never become available for viewing, and may correspond to (i.e., be related to) or be unrelated to one or more of the media listings in grid 302. Advertisement 324 may also be for products or services related or unrelated to the media content displayed in grid 302. Advertisement 324 may be selectable and provide further information about media content, provide information about a product or a service, enable purchasing of media content, a product, or a service, provide media content relating to the advertisement, etc. Advertisement 324 may be targeted based on a user's profile/preferences, monitored user activity, the type of display provided, or on other suitable targeted advertisement bases. Advertisement 324 can be provided to the user device displaying display 300 by advertisement gateway 102 of FIG. 1. For example, the user device or the software that displays display 300 can determine that there is a space for an advertisement (e.g., the area where advertisement 324 is displayed).

Upon determining that there is space for the advertisement, the user device requests an advertisement for that space from advertisement gateway 102. Advertisement gateway 102 in turn selects an advertisement source (e.g., one of advertisement sources 108) and requests the advertisement from the selected advertisement source. Advertisement gateway 102 then receives the advertisement from the selected advertisement source and transmits it to the requesting user device for display as advertisement 324.

While advertisement 324 is shown as rectangular or banner shaped, advertisements may be provided in any suitable size, shape, and location in a guidance application display. For example, advertisement 324 may be provided as a rectangular shape that is horizontally adjacent to grid 302. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user device with the guidance application, in a database connected to the user device, in a remote location (including streaming media servers), or on other storage means or a combination of these locations. Providing advertisements in a media guidance application is discussed in greater detail in, for example, Knudson et al., U.S. Patent Application Publication No. 2003-0110499, published Jun. 12, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 326 may allow the user to access different types of media content, media guidance application displays, and/or media guidance application features. Options region 326 may be part of display 300 (and other display screens of the present invention), or may be invoked by a user by selecting an on-screen option or pressing a dedicated or assignable button on a user input device. The selectable options within Options region 326 may concern features related to program listings in grid 302 or may include options available from a main menu display. Features related to program listings may include searching for other air times or ways of receiving a program, recording a program, scheduling a reminder for a program, ordering a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other websites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. Additional personalized media guidance application features are described in greater detail in Ellis et al., U.S. Patent Application Publication No. 2005-0251827, published Nov. 10, 2005, Boyer et al., U.S. Pat. No. 7,165,098, issued Jan. 16, 2007, and Ellis et al., U.S. Patent Application Publication No. 2002-0174430, published Nov. 21, 2002, which are hereby incorporated by reference herein in their entireties.

FIG. 4 shows illustrative microsite 400 showing various promotional features in accordance with some embodiments of the present disclosure. Microsite 400 may include media 404, interactive microsite options 406, 408, 410, navigational icons 412, and menu options 414. Typically, microsite 400 includes promotional content associated with an advertiser. Microsite 400 may be invoked by a user selecting an advertisement in a media guidance application (e.g., advertisement 324 of FIG. 3). Alternatively, microsite 400 may also be invoked by a media guidance application upon determining that a user is likely to be interested in a particular product or service associated with 400. Microsite 400 may partly or fully overlay a previously displayed display screen of a media guidance application (such as display 300 of FIG. 3).

In some embodiments, microsite 400 may include menu options 414 for navigating through the various portions of a media guidance application. For example, with a user input device (e.g., a remote control for a set-top box), a user may select menu option 416, invoking the display of microsite 400. Menu option 416 may be emphasized to indicate that it has been selected by a user. Emphasis may be added to any menu option by visually distinguishing the menu option (e.g., shading the menu option with a distinguishing color).

Microsite options 406, 408, 410 may be an interactive or noninteractive image, text, or video. In some embodiments, options 406, 408, 410 are individual interactive advertisements for particular products or services that the microsite owner (e.g., the advertiser) wishes to promote. In such an embodiment, selection of one of options 406, 408, or 410 provides further information regarding the products or a method to purchase the respective products. In some embodiments, microsite 400 may be an interactive website that includes graphics and interactive content related to a particular type of media (e.g., a movie). In such an embodiment, selection of one of options 406, 408, or 410 provides additional information about the associated media (e.g., cast and character information). In some embodiments, options 406, 408, or 410 relate to social media capabilities. For example, a user can log into their favorite social networking website so that the user or microsite may interface with their social networking profile (e.g., “like” the movie associated with the microsite).

In some embodiments, the background of microsite 400 may include a branded wrap or skin. For example, the background of microsite 400 may include a background with an image or a logo that is related to the advertiser or product or service being advertised in microsite 400.

The advertisement assets and other information for displaying and interacting with microsite 400 may be provided to the user device directly from one of third party servers 114 of FIG. 1 (e.g., microsite server 120) directly or indirectly via advertisement gateway 102.

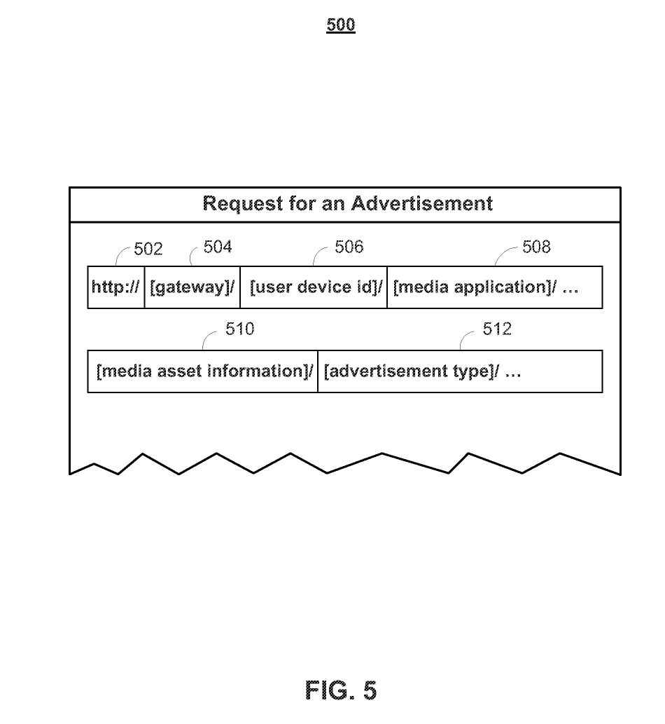

FIG. 5 shows illustrative advertisement request 500 in accordance with some embodiments of the present disclosure. For example, request 500 may be a request for advertisement 324 of FIG. 3 that is generated by user devices 104 of FIG. 1 and sent to advertisement gateway 102. Request 500 may also represent a request sent to an advertisement source from advertisement gateway 102 after advertisement gateway 102 receives an advertisement request from a user device, selects an advertisement source, and translates and/or reformats the initial advertisement request to be compatible with the selected advertisement source. In response to receiving advertisement request 500, advertisement gateway 102 may select an advertisement source (e.g., one of advertisement sources 108) based on routing rules, as will be discussed further below.

Upon receiving request 500, advertisement gateway 102 will translate request 500 into a format that is compatible with the selected advertisement source. Advertisement gateway 102 then sends the translated request to the selected advertisement source, which processes the request and sends a response with an advertisement or instructions on where to retrieve the advertisement (e.g., the location of the advertisement within one of third party servers 114). Advertisement gateway 102 then formats in a manner compatible with the requesting user device and sends a response associated with the selected advertisement to the requesting user device (e.g., the response includes the advertisement itself or a link to the advertisement for retrieval by the user device).

Advertisement request 500 may be a data structure formatted based on a suitable messaging protocol, as shown in FIG. 5. Exemplary messaging protocols may include, without limitation, Representational State Transfer (REST), Services-Orient Access Protocol (SOAP), JavaScript Object Notation (JSON), Extensible Markup Language (XML), or any other suitable messaging protocols. Typically, messaging protocols are based on a client-server framework. In particular, a client (e.g., user device 104 of FIG. 1) may transmit a request to a server (e.g., advertisement gateway 102 of FIG. 1). In some embodiments, the messaging protocols are based on a peer-to-peer framework. In response to receiving a request from the client, the server processes the request and transmits a response to the client. For example, REST is a protocol based on a client-server framework that relies on the transfer of representations of resources, which represents the states of data that are being transferred. Advertisement gateway 102 of FIG. 1 is sufficiently flexible to handle any of the messaging protocols as discussed above or any other suitable protocol. For example, advertisement gateway 102 may be capable of processing requests formatted using REST from one user device in addition to processing requests formatted using SOAP from another user device.

By way of example, advertisement request 500 is formatted using the REST messaging protocol in FIG. 5. Once formatted, advertisement request 500 may then be transmitted over a communications network to an advertisement gateway (e.g., advertisement gateway 102 of FIG. 1) using any suitable communications protocol. For example, advertisement request 500 may be transmitted using the HTTP protocol in FIG. 5 (as indicated by customizable field 502). Advertisement request 500 may include customizable fields 504, 506, 508, 510, and 512, the contents of which will be discussed further below. Although only six customizable fields are shown in FIG. 5, the number of customizable fields may be extended to any finite number without departing from the scope of the present disclosure. For example, a user device manufacturer and a provider hosting an advertisement gateway may agree to add an additional customizable field to advertisement request 500 if a technical need arises requiring that particular customizable field.

Field 504 may be the network address for the server or gateway that will process the advertisement request, for example, advertisement gateway 102 of FIG. 1. In some embodiments, request 500 may be sent to an intermediary server before being transmitted to advertisement gateway 102. As such, field 504 may include the network address of the intermediary server.

Field 506 includes information regarding the requesting user device (e.g., the user device that transmitted the request). In some embodiments, field 506 includes information that identifies the manufacturer and device model of the user device sending advertisement request 500. In some embodiments, generic or default device model/manufacturer information may be included in field 506 when the actual device model is not available or when information about the device is not needed to properly display the requested advertisement. In some embodiments, field 506 identifies various characteristics of the requesting device. For example, the screen size, acceptable media formats, processing and graphics capabilities. As such, the entity that chooses the advertisement for display at the requesting user device can select an advertisement that is acceptable or optimal for display on the user device.

In some embodiments, field 506 includes the network address of the requesting user device. This may be utilized by advertisement gateway 102 to send the advertisement response back to the requesting device. In some embodiments, field 506 includes information regarding messaging protocols for advertisements responses that are compatible with the requesting user device, such as any of the messaging protocols described above. In some embodiments, field 506 indicates the version of the user device that is requesting the advertisement. In some embodiments, peripherals may be attached to the user device which may be involved in requesting or displaying the advertisement. In such embodiments, field 506 may identify properties of the appropriate peripherals (e.g., peripheral type, manufacture, processing capabilities, etc.). In some embodiments, a user device may include more than one display screen. In such embodiments, field 506 may indicate which screen of the multiple screens will display the advertisement.

Field 508 identifies the software application that is requesting the advertisement. For example, if the requested advertisement will be placed within a particular software application, the software application will originate the advertisement request. For example, field 508 may identify a media guidance application that will display the advertisement. In some embodiments, the advertisement request originating software may be a widget that runs within a media guidance application. In such embodiments, field 508 may identify the widget. In some embodiments, field 508 includes information regarding where within the software application display the requested advertisement will be displayed. For example, a software application may support multiple advertisements in different positions within a particular display screen. In such embodiments, field 508 will indicate for which position the requested advertisement is destined.

In some embodiments, field 508 includes information regarding the version of the software application. The information in field 508 may be utilized by advertisement gateway 102 or the advertisement sources to select advertisements that are compatible for display within the requesting device's software. In some embodiments, a media guidance application, a third party application, or any suitable software/hardware platforms may be the originator of the advertisement request. Accordingly, in these embodiments, field 508 may identify the respective originators of the advertisement requests.

Field 510 may identify information related to a media asset (e.g., a television program) that is stored, being presented, tuned to, and/or highlighted in a guidance application running on the user device that is requesting the advertisement. Exemplary media asset information may include, without limitation, program identifications, series identifications, source identifications (e.g., server that provides the media), source group identifications, celebrity identifications (e.g., celebrities in the currently viewed program or celebrities that user has been found to be interested in), genre identifications, or other types of media identifications. Program identifications may include identification for a program that is currently highlighted in a media guidance application or identification for a program that is currently tuned in a tuner of the user device. Series identifications may include identification for the series of a program that is currently highlighted in a media guidance application or the series of a program that is currently tuned in a tuner of the user device. Source identifications may include the source originator of a program that is currently highlighted in a media guidance application or the source originator of a program that is currently tuned in a tuner of the user device. Genre identifications may include the genre of a program that is currently highlighted in a media guidance application or the genre of a program that is currently tuned in a tuner of user device. In addition to media identifications, field 510 may also include information related to time zone, local time, daylight savings information, country, postal code, and language about a program that may be stored or presented on the user device.

Field 512 may identify the type of advertisement that is being requested by the user device. Exemplary types of advertisements may include, without limitation, banner advertisement, menu advertisement, or wrap advertisement. In some embodiments, field 512 may identify whether the requested advertisement should be targeted to the user. In embodiments where the advertisement is to be targeted to the user, advertisement request 500 may include a plurality of targeting parameters (e.g., behavioral, contextual, search, geographical, and/or demographic based targeting parameters) that may be used to select a targeted advertisement. The targeting parameters may at least in part reflect media consumption habits of a user of a user device in addition to or alternative to the information that may be included in advertisement request 500 as described above. In some embodiments, field 512 may specify whether the requested advertisement should include audio and/or video. Additionally, or alternatively, field 512 may specify the dimensions of the advertisement and/or the quality of the advertisement (e.g., image resolution).

In some embodiments, the user devices may request particular formats to use when transmitting an advertisement request. For example, the user device may indicate what response format(s) the device will accept within the advertisement request. As a specific example, the advertisement request may indicate that the requesting device will only accept advertisement responses in JSON and REST formats. In some embodiments, if the advertisement request does not indicate acceptable formats, advertisement gateway 102 will provide advertisement responses in a default format.

In some embodiments, any of the fields in request 500 may include multiple values. For example, a program may be associated with more than one genre, and as such, field 510 may include more than one genre when requesting an advertisement. Advertisement request 500 may be sent over a communications network using a variety of communications protocols. Exemplary communication protocols may include, without limitation, Hypertext Transfer Protocol (HTTP), Hypertext Transfer Protocol Secure (HTTPS), Telnet, Secure Shell (SSH), Extensible Messaging and Presence Protocol (XMPP) or Secure Sockets Layer (SSL). Typically, HTTP and HTTPS are used as communications protocol for transmitting web-based requests on user device; however, any of the foregoing communications protocols may be employed depending upon the nature of the request. Additionally, new protocols and revisions of existing communications protocols may be introduced, all of which may be used for transmitting advertisement request 500 in view of the above discussion without departing from the scope of the present disclosure.

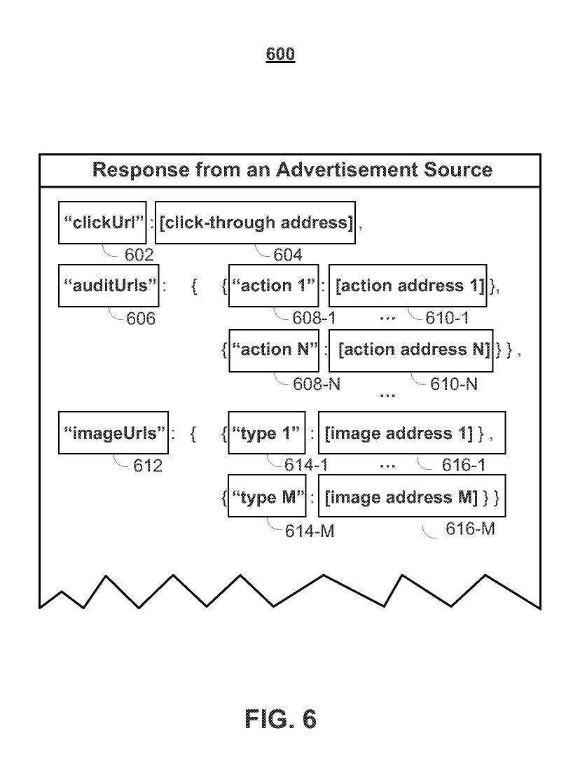

FIG. 6 shows illustrative advertisement response 600 in accordance with embodiments of the present disclosure. For example, response 600 may be sent to a user device in response to an advertisement request (e.g., advertisement request 500 of FIG. 5). Response 600 includes information regarding an advertisement that was selected by an advertisement source for display in response to the initial advertisement request. For example, response 600 may include an advertisement identifier that may be used by advertisement asset server to retrieve the appropriate advertisement assets upon retrieval request by the user device. In some embodiments, response 600 is a header on the packets that include the advertisement data itself. For example, the advertisement source may transmit the selected advertisement graphics and attach the information regarding the selected advertisement (i.e., response 600) as a header on the advertisement graphic information.

The advertisement may be selected by the advertisement source based on targeting parameters, device specifications, parameters specified in the advertisement request, randomly from a plurality of advertisements, value of the advertisement, and/or any other suitable advertisement selection mechanism. Generally, response 600 is transmitted to advertisement gateway 102 from an advertisement source after advertisement gateway 102 sends a translated advertisement request to the advertisement source. After receiving the response that includes information regarding the selected advertisement from the advertisement source, advertisement gateway 102 may translate the response into a format that is compatible with the user device that originally sent the advertisement request.

Advertisement response 600 may be represented as a data structure formatted using a messaging protocol, as shown in FIG. 6. Exemplary messaging protocols are discussed above in detail in connection with FIG. 5. Those skilled in the art would appreciate that an advertisement gateway may send advertisement response 600 using any suitable messaging protocols over any suitable communications protocols. Exemplary messaging and communications protocols are discussed above in connection with FIG. 5. Advertisement response 600 may include customizable fields 602, 606 and 612.

Customizable field 602 is associated with customizable field 604. Customizable field 606 is associated with customizable fields 608-1 up to 608-N and 610-1 up to 610-N, where N is a nonnegative integer. Customizable field 612 is associated with customizable fields 614-1 up to 614-N and 616-1 up to 616-M, where M is a nonnegative integer. Although a limited number of customizable fields are shown in FIG. 6, the number of customizable fields may be extended to any finite number without departing from the scope of the present disclosure. For example, a user device manufacturer and a provider hosting an advertisement gateway may agree to add an additional customizable field to advertisement response 600 if a need arises requiring that particular customizable field.

Field 604 may be a Uniform Resource Locator (“URL”) that specifies an address of a website or server to redirect an application (e.g., a media guidance application or a widget) when a user clicks on an advertisement. For example, upon clicking an advertisement, the user may be directed to a microsite provided by microsite server 120 of FIG. 1. As such, field 604 may include the network address of microsite server 120. The response to a request based on field 604 may be a 302 redirection command. The application may then load the website to which the application was redirected. The redirected website may provide additional promotional content associated with the advertisement. For example, when a user clicks on an advertisement for a television program, user device 104 of FIG. 1 will access the website address associated with field 604 and display it on user device 104. The accessed website may present promotional content associated with the advertisement (e.g., clothing associated with the advertised television program).

Fields 610-1 up to 610-N specify “auditUrls” which are URLs that specify the addresses of websites or servers for reporting actions that may be performed by a user. For example, actions performed by a user may be reported to the audit servers of third party servers 114 or FIG. 1. As such, the audit servers' network address may be included in the appropriate field 610. The specific actions that are reported to the auditUrls are defined by respective fields 608-1 to 608-N. In some embodiments, multiple auditUrls may be defined for the same action (e.g., two auditUrls are defined for a record action). In such embodiments, both auditUrls are invoked. They may be invoked at substantially the same time. This allows multiple auditors to record a user's actions with respect to an advertisement. Exemplary actions that may be reported to audit servers may include, without limitation, impression, clicks, click-throughs, time of delivery, geographic location of delivery, purchase, information requests, viewing durations, record, remind, and watch. These actions may allow an advertisement gateway (e.g., advertisement gateway 102 of FIG. 1) to determine media consumption habits of a user. Based on these determined media consumption habits, the advertisement gateway may formulate which are used in selecting an advertisement source in response to receiving a request for an advertisement (e.g., advertisement request 500 of FIG. 5) from a user device.

An impression action may indicate that a delivered advertisement was displayed on a user device. The URL associated with an impression action may be invoked by an application when an advertisement is displayed on a display of a user device. For example, field 608-1 may be configured as an impression action with the corresponding URL indicated by field 610-1. In response to displaying the advertisement indicated by advertisement response 600, an impression action may be registered by an advertisement gateway (e.g., advertisement gateway 102 of FIG. 1) or one of third party servers 114. Monitoring impressions accommodates situations where a user device pre-fetches an advertisement and may or may not display the pre-fetched advertisement.

A click action may indicate when an advertisement was clicked by a user. The URL associated with a click action may be invoked by an application when a user clicks on an advertisement. For example, field 608-1 may be configured as a click action with the corresponding URL indicated by field 610-1. In response to determining that a user has clicked on an advertisement indicated by advertisement response 600, a click action may be registered by an advertisement gateway (e.g., advertisement gateway 102 of FIG. 1) or one of third party servers 114.

A record action may indicate when a user opts to record a program that was featured in an advertisement. The URL associated with a record action may be invoked by an application when a user opts to record a program that was featured in an advertisement. For example, field 608-1 may be configured as a record action with the corresponding URL indicated by field 610-1. In response to determining that a user has decided to record a particular program that was featured in an advertisement indicated by advertisement response 600, a record action may be registered by an advertisement gateway (e.g., advertisement gateway 102 of FIG. 1) or one of third party servers 114.

A remind action may indicate when a user opts to set a reminder for a media asset (e.g., a television program) that was featured in an advertisement. The URL associated with a remind action may be invoked by an application which sets up a reminder for the media asset (e.g., a reminder when the media asset is broadcasted) that was featured in the advertisement. For example, field 608-1 may be configured as a remind action with the corresponding URL indicated by field 610-1. In response to receiving a remind action for a media asset that was featured in an advertisement indicated by advertisement response 600, a remind action may be registered by an advertisement gateway (e.g., advertisement gateway 102 of FIG. 1) or one of third party servers 114.

A watch action may indicate when a user opts to tune to a media asset that was featured in an advertisement. The URL associated with a remind action or a watch action may be both invoked by an application when a user opts to set up a reminder for a media asset that was featured in an advertisement. For example, field 608-1 may be configured as a watch action with the corresponding URL indicated by field 610-1. In response to determining that a user has tuned to a media asset that was featured in an advertisement indicated by advertisement response 600, a watch action may be registered by an advertisement gateway (e.g., advertisement gateway 102 of FIG. 1) or one of third party servers 114. In some embodiments, the user actions taken may be registered at the advertisement source that provided the advertisement via advertisement response 600.

Fields 616-1 up to 616-M may be URLs that specify addresses of websites or servers that contain images that are associated with an advertisement indicated by advertisement response 600. For example, fields 616 may refer to advertisement asset server 116 of FIG. 1. Exemplary types of advertisement images may include, without limitation, a default image, a thumbnail, or an expanded image. A default image may be provided when there are no images that are provided with the advertisement indicated by advertisement response 600. A thumbnail may be an advertisement image that has been downsized so that it may be more readily displayed on a display of a user device. An expanded image may be an advertisement image that is provided as a high-resolution version of the advertisement image.

In some embodiments, response 600 includes an ordinal number (not shown in FIG. 6). The ordinal number indicates the position of an advertisement within a stack of advertisement assets (e.g., graphics overlaid upon video). By using an ordinal number, user devices do not need to make multiple advertisement requests (e.g., one for each advertisement asset in the stack). Rather, the user device may make a single advertisement request, and in turn, receive multiple responses that are ordered using the ordinal number.

In some embodiments, advertisement gateway 102 has HTTP header support. The user devices (e.g., user devices 104 of FIG. 1 are expected to store all cookies returned as HTTP headers in response 600. The user devices then send the cookies back to advertisement gateway 102 as HTTP headers. For example, a particular advertiser may include cookies along with an advertisement response. The user device updates the cookies appropriately and then transmits the updated cookies to advertisement gateway 102.

In some embodiments, if advertisement gateway 102 or one of advertisement sources 108 receives an advertisement request (e.g., advertisement request 500 of FIG. 5) with invalid parameters, the respective server/device will return an empty response. For example, an advertisement request may include invalid values for parameters that are essential for an advertisement source to select an advertisement (e.g., invalid manufacture identifier), and as such, the advertisement source may return an empty response upon receiving the advertisement request with invalid values. In some embodiments, an empty response is returned by advertisement gateway 102 or one of advertisement sources 108 when there are no suitable advertisements to select. For example, an advertisement source may not have any advertisements that match the parameters of the advertisement request or have an active advertisement campaign, and as such, may return an empty response upon receiving and/or processing the advertisement request.

In some embodiments, a timed out response may be considered an empty response. For example, after sending an advertisement request to an advertisement source, advertisement gateway 102 may wait a predetermined amount of time for an advertisement response. If no response is received within the predetermined amount of time, gateway 102 may consider the lack of response an empty response. This may occur when the advertisement source is offline, down for maintenance, and/or servicing, etc.

In some embodiments, gateway 102 may update its list of available advertisement sources after receiving an empty response or not receiving a response at all from the advertisement source. For example, if no response is received from an advertisement source, the advertisement gateway may consider the advertisement source unresponsive and likely unavailable. It would be prudent not to continue to send advertisement requests to advertisement sources that are unavailable. In some embodiments, the advertisement gateway maintains records associated with what advertisements and types of advertisements are available/not available at the respective advertisement sources so that advertisement requests that request a particular advertisement will not be sent to an advertisement source that previously returned an empty response for the same or similar type of advertisement.

When empty responses are received, the advertisement gateway may update its routing rules, weights associated with the advertisement sources, or a list of available advertisement sources such that the unresponsive advertisement source is not selected for future advertisement requests. In some embodiments, the advertisement gateway pings the unresponsive advertisement source periodically to determine whether the unresponsive advertisement source is available again. In some embodiments, the advertisement gateway pings the advertisement sources to determine what advertisements and types of advertisements are available at the respective advertisement sources. In this manner, the advertisement gateway can respond to network and advertisement source changes in real-time while maintaining an ability to respond to advertisement requests from user devices and provide them with advertisements, even when some advertisement sources are unavailable or do not have advertisements that match the requirements of an advertisement request.

The empty response may include default parameters. The default parameters may include a default click-thru URL and/or default advertisement asset URLs. A response that includes default parameters may be referred to herein as a default response. Default responses would be transmitted from the advertisement gateway to the requesting user device in a format that is compatible with the user device. In some embodiments, when advertisement gateway 102 receives an empty response, gateway 102 creates a different response that includes references to the default parameters. In some embodiments, the default parameters are parameters that would be compatible with a majority or a significant percentage of the user devices that may have sent the advertisement request. For example, if an advertisement source is unable to determine what type of device sent the advertisement request, the advertisement source will return an advertisement response with default data that is likely to be compatible with the unknown device. In some embodiments, an empty response is an advertisement response that does not include any advertisement information. This response may serve as an indication to the requesting device that its advertisement request was defective. In some embodiments, the empty response indicates what parameter(s) was invalid in the advertisement request.

Although the foregoing discussion with respect to FIG. 5 and FIG. 6 have discussed request 500 and response 600 with respect to particular protocols, request 500 and response 600 may be implemented using any suitable messaging protocol. In some instances, an advertisement request and an advertisement response may be formatted using the same messaging protocol. In other instances, an advertisement request and an advertisement response may be formatted using different messaging protocols. For example, this may be suitable for a system in which it is technically more efficient to receive a request using one messaging protocol (e.g., REST) and to send a response using another messaging protocol (e.g., JSON).

The following flow charts serve to illustrate processes involved in accordance with some embodiments of the present disclosure. The processes may be implemented using any suitable combination of hardware (e.g., microprocessor, FPGAs, ASICs, and/or any other suitable circuitry) and/or software in any suitable fashion. It should be understood that the steps of the flow charts are merely illustrative and any of the depicted steps may be modified, omitted, or rearranged, two or more of the steps may be combined, or any additional steps may be added, without departing from the scope of the present disclosure.

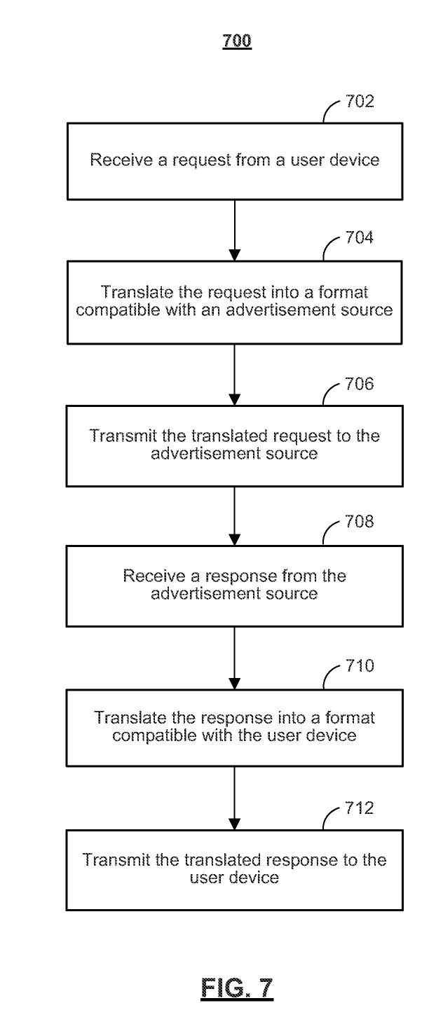

FIG. 7 depicts generalized illustrative process 700 for handling an advertisement request (e.g., advertisement request 500 of FIG. 5) at an advertisement gateway (e.g., advertisement gateway 102 of FIG. 1). In particular, process 700 relates to embodiments where only one advertisement source (e.g., one of advertisement sources 108) is connected to the advertisement gateway or there are multiple advertisement sources, but no decision metric is set to select one source over the other when advertisement request is received. In situations where there is only one advertisement source connected to the advertisement gateway, the advertisement gateway does not have to make any advertisement source selection decisions, but rather, forwards any received advertisement requests to the solitary advertisement source after reformatting the advertisement request as appropriate. In situations where there are multiple advertisement sources connected, but no decision metric set, the advertisement gateway forwards any received advertisement requests to a default advertisement source.

At step 702, an advertisement request is received from a user device at, for example, advertisement gateway 102 of FIG. 1. This advertisement request may be substantially similar to advertisement request 500 of FIG. 5. At step 704, the received advertisement request is translated into a format that is compatible with the solitary or default advertisement source that is connected to the advertisement gateway. For example, the advertisement request received at step 702 may in be in REST format, but the advertisement source is only compatible with JSON format. In such a situation, the advertisement gateway will reformat the REST advertisement request into a JSON advertisement request. In some embodiments, translating the request may involve translating the values of parameters within the request. For example, user devices and advertisement source may have different program identification schemes. As such, the advertisement source may translate the user device's program identification scheme into a program identification scheme that is compatible with the advertisement source.

In some embodiments, when advertisement gateway receives the advertisement request at step 702, the gateway determines whether it has received a similar request in the past (e.g., recent past). If so, there may not be a need to select an advertisement source and forward the advertisement request to that advertisement source. Instead, the gateway may store recent advertisement responses in its storage (e.g., storage 206) and compare advertisement requests to the advertisement responses stored in its storage. If a match is found (e.g., a response whose characteristics match the requirements of the advertisement request), the advertisement gateway may retrieve the stored response and transmit it to the user device that sent the advertisement request.

In some embodiments, the advertisement gateway adds additional information to and/or removes information from the advertisement request. For example, the advertisement gateway may include additional or specific information about the advertisement that should be selected in response to the advertisement request. For example, a particular advertiser may have requested that their advertisements be provided in response to certain advertisement requests. As such, the advertisement gateway may include in the request a specific request for an advertisement associated with the advertiser. As an additional example, advertisement gateway may add additional targeting parameters into the advertisement request. In some embodiments, step 704 is skipped by the advertisement gateway when, for example, the advertisement request received at step 702 is already in a format that is compatible with the advertisement source.

At step 706, the translated advertisement request is transmitted to the advertisement source for processing. For example, the advertisement source uses the information in the transmitted advertisement request to select an advertisement to provide to the user device that requested that advertisement. At step 708, an advertisement response (e.g., advertisement response 600 of FIG. 6) is received at, for example, the advertisement gateway. Once the advertisement response is received, process 700 proceeds to step 710.

At step 710, the advertisement response is translated into a format compatible with the user device (e.g., the user device that sent the advertisement request received at step 702). For example, the advertisement response may be in JSON format and the user device is only compatible with REST format. In such a situation, the advertisement gateway will reformat the JSON advertisement response into a REST advertisement response. In some embodiments, translating the response may involve translating the values of parameters within the response. For example, user devices and advertisement source may have different program identification schemes. As such, the advertisement source may translate the advertisement source's program identification scheme into a program identification scheme that is compatible with the user device.

In some embodiments, step 710 is skipped by the advertisement gateway when, for example, the advertisement response received at step 708 is already in a format that is compatible with the user device. After formatting the advertisement response, process 700 proceeds to step 712. At step 712, the translated advertisement response is transmitted to the user device that sent the advertisement request that was received at step 702. When the user device receives the translated advertisement response, the user device may present the advertisement identified in the advertisement response to the user or save the advertisement information to storage (e.g., local storage) for later presentation.

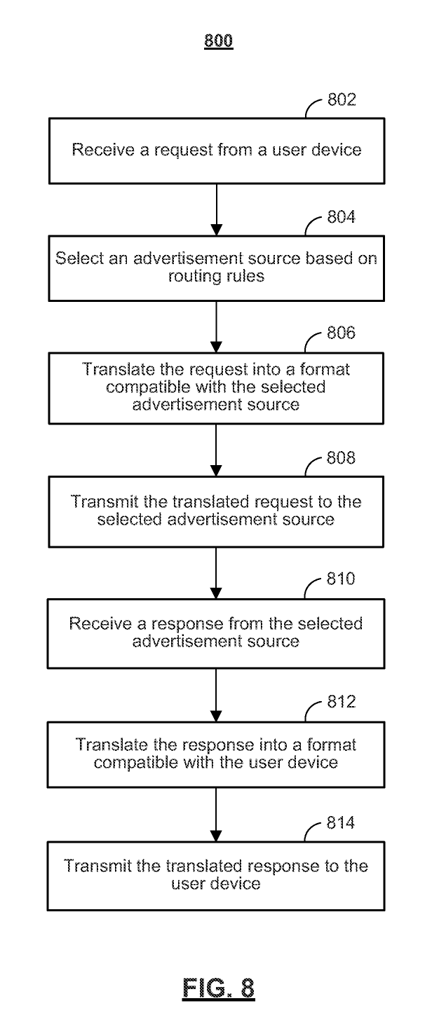

FIG. 8 depicts generalized illustrative process 800 for handling an advertisement request (e.g., advertisement request 500 of FIG. 5) at an advertisement gateway (e.g., advertisement gateway 102 of FIG. 1). In particular, process 800 relates to embodiments where multiple advertisement sources are connected to the advertisement source and decision metrics (i.e., routing rules) have been set to select one source over the other when advertisement request is received.

The advertisement request routing rules may be based on the context of available advertisements at the respective advertisement sources. For example, the advertisement gateway may select an advertisement source where the available advertisements are more likely to match the targeting parameters that are included in the advertisement request. The routing rule may additionally be based on the time of day that the advertisement request is sent. For example, some advertisement sources may have an inventory of advertisements that are better suited to be displayed in the morning versus the evening. As such, if an advertisement request is received in the morning, the advertisement gateway is more likely to select an advertisement source that has a larger inventory of advertisements that are suited to be displayed in the morning.

In some embodiments, the routing rules may be based on the value of available advertisements at the respective advertisement sources. For example, the advertisement gateway is more likely to select an advertisement source that has a larger inventory of high value advertisements versus an advertisement source that has a larger inventory of low value advertisements. The value of the advertisements may be based on the price the respective advertiser is willing to pay for an impression, click-through, etc. Additionally, or alternatively, the value of advertisements may be based on the likelihood of an impression or click-through. For example, high quality video advertisements are more likely to attract click-throughs versus low quality image advertisements.

In some embodiments, the routing rules may be based on campaign profitability of the advertisements and/or predetermined advertisement source priorities. For example, advertisement sources may be assigned priority designations by the operator of the advertisement gateway. The priority designation indicates how often an advertisement source should be selected in response to receiving an advertisement request. For example, high priority advertisement sources may be selected 70% of the time, while low priority advertisement sources may be selected 30% of the time. As a further example, the advertisement sources may be prioritized based on the type of advertisement source. For example, an advertisement network may be a higher priority than an advertisement server. As a further example, advertisement sources with larger and/or more valuable inventories may be associated with higher priorities than advertisement sources with smaller and/or less valuable inventories.

In some embodiments, the advertisement sources may be associated with weights based on the aforementioned parameters and characteristics. Advertisement gateway 102 may then use the weights to select the appropriate advertisement source after receiving an advertisement request. For example, when an advertisement request is received, advertisement gateway 102 may select the advertisement source that is associated with the largest or substantially the largest weight value. In some embodiments, advertisement gateway 102 may only select an advertisement source whose weight has reached a particular threshold. In such an embodiment, if none of the advertisement sources are associated with a weight that is equal to or above the designated threshold value, advertisement gateway 102 may select a default advertisement source or the advertisement source that is associated with the largest or substantially the largest weight value.

At step 802, an advertisement request is received from a user device at, for example, advertisement gateway 102 of FIG. 1. This advertisement request may be substantially similar to advertisement request 500 of FIG. 5. After receiving the advertisement request, process 800 proceeds to step 804.

At step 804, the advertisement gateway selects an advertisement source based on the routing rules. As noted above, the routing rule may be based on the inventory of the various advertisement sources, advertisement campaign profitability, and/or priority designations associated with the advertisement sources. Once an advertisement source is selected, process 800 proceeds to steps 806-814. Steps 806-814 are substantially similar to steps 704-712 of FIG. 7, respectively, except that the advertisement source discussed in steps 806-814 was selected based on routing rules.

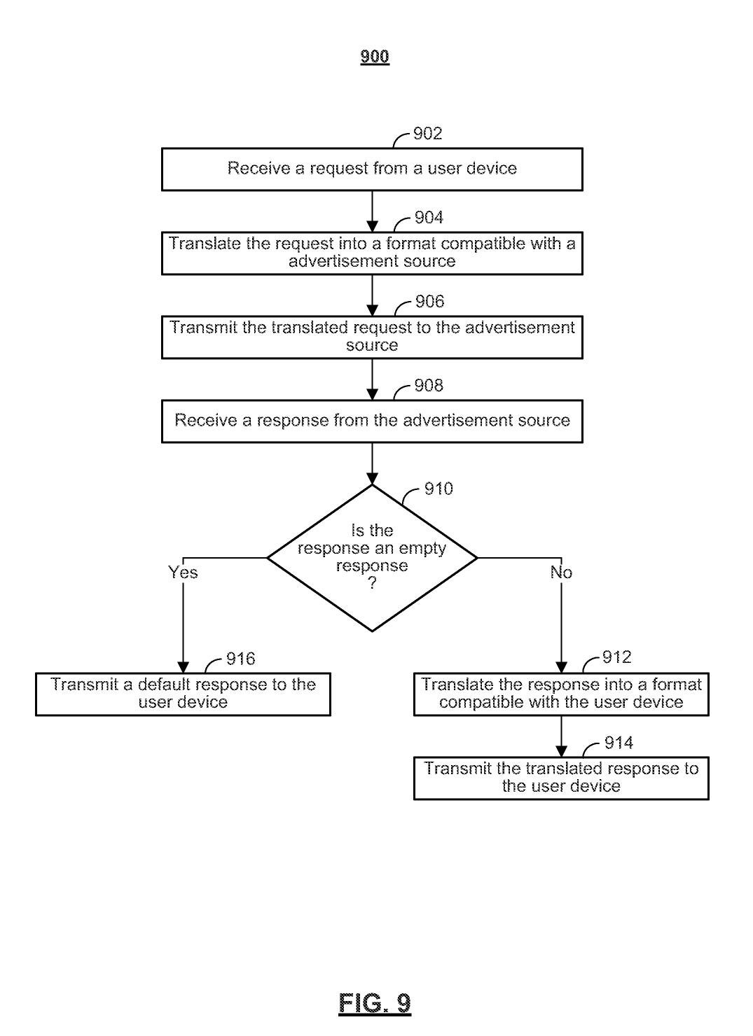

FIG. 9 depicts a generalized illustrative process 900 for handling an advertisement request (e.g., advertisement request 500 of FIG. 5) at an advertisement gateway (e.g., advertisement gateway 102 of FIG. 1). In particular, process 900 relates to embodiments where an empty response is received in a situation where only one advertisement source (e.g., one of advertisement sources 108) is connected to the advertisement gateway or there are multiple advertisement sources, but no decision metric is set to select one source over the other when advertisement request is received. In situations where there is only one advertisement source connected to the advertisement gateway, the advertisement gateway does not have to make any advertisement source selection decisions, but rather, forwards any received advertisement requests to the solitary advertisement source after reformatting the advertisement request as appropriate. In situations where there are multiple advertisement sources connected, but no decision metric set, the advertisement gateway forwards any received advertisement requests to a default advertisement source. Steps 902-908 are substantially similar to steps 702-708 of FIG. 7, respectively.

At step 910 it is determined whether the response received from the advertisement source at step 908 is an empty response (e.g., an empty response substantially similar to the empty response described above with regard to FIG. 6). If the response is not an empty response, process 900 proceeds to step 912. Steps 912 and 914 are substantially similar to steps 710 and 712 of FIG. 7, respectively. If the response is an empty response, process 900 proceeds to step 916. At step 916, a default response is transmitted to the user device. For example, advertisement gateway 102 of FIG. 1 may determine that the response from the advertisement source is an empty response, and in response to that determination, retrieve a default response that is compatible with the requesting user device or translate the retrieved default response into a format that is compatible with the user device. Once the default response is retrieved, advertisement gateway 102 transmits the default response to the user device. The default response may be substantially similar to the default response discussed above with regard to FIG. 6.

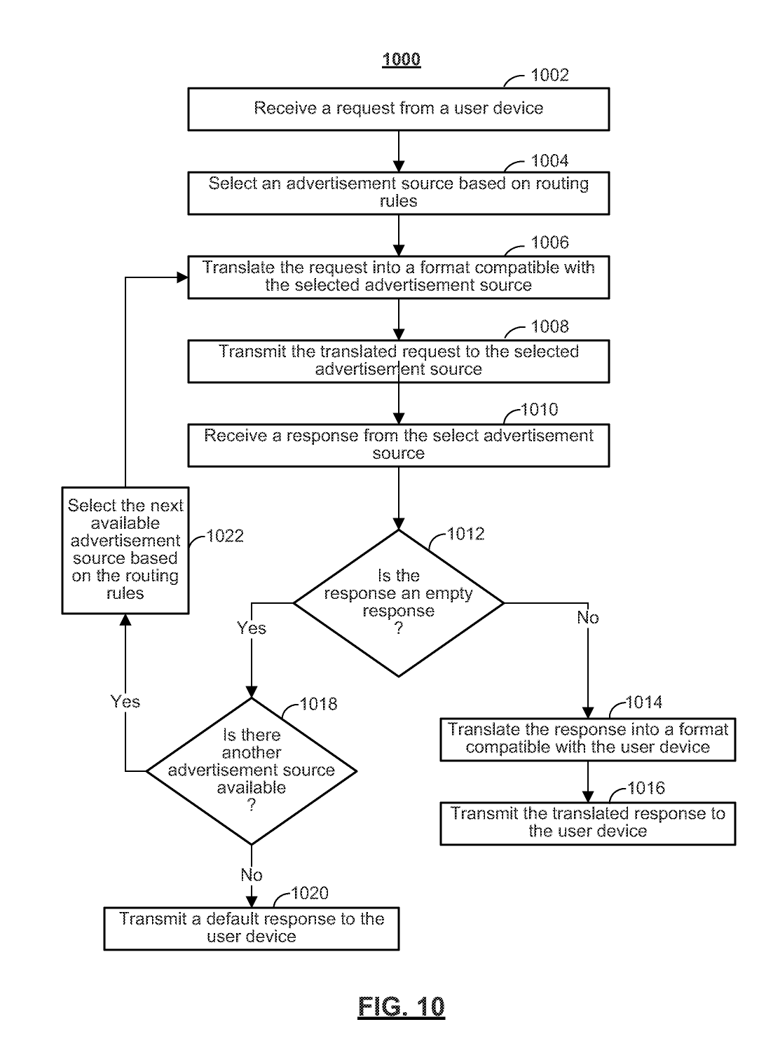

FIG. 10 depicts generalized illustrative process 1000 for handling an advertisement request (e.g., advertisement request 500 of FIG. 5) at an advertisement gateway (e.g., advertisement gateway 102 of FIG. 1). In particular, process 1000 relates to embodiments where an empty response is received in situations where multiple advertisement sources are connected to the advertisement source and decision metrics (i.e., routing rules) have been set to select one source over the other when advertisement request is received. Steps 1002-1010 are substantially similar to steps 802-810 of FIG. 8.

At step 1012, it is determined whether the response received from the advertisement source at step 1010 is an empty response (e.g., an empty response substantially similar to the empty response described above with regard to FIG. 6). If the response is not an empty response, process 1000 proceeds to step 1014. Steps 1014 and 1016 are substantially similar to steps 812 and 814 of FIG. 8. If the response is an empty response, process 1000 proceeds to step 1018.

At step 1018, it is determined whether there are any other advertisement sources available. For example, an empty response from the initially selected advertisement source may indicate that the initially selected advertisement source does not have any available advertisements that satisfy the requirements of the advertisement request. As such, advertisement gateway 102 may attempt to select another advertisement source to satisfy the advertisement request before responding to the request with a default response.

As noted above, advertisement gateway 102 may remove the selected advertisement source from its list of available advertisement sources when an advertisement source is unresponsive or unable to fulfill an advertisement request so that gateway 102 does not continue to forward advertisement requests to advertisement sources that are unable to satisfy the advertisement requests. If at step 1018 it is determined that there is no other advertisement source available to fulfill the advertisement request, process 1000 proceeds to step 1020. At step 1020, a default response is transmitted to the user device that sent the advertisement request. Step 1020 is substantially similar to step 916 of FIG. 9.

If at step 1018 it is determined that there is at least one other available advertisement source, process 1000 proceeds to step 1022. At step 1022, the next available advertisement source is selected based on routing rules. This process may be substantially similar to the process to select the initially selected advertisement source (e.g., the advertisement source that provided the empty response), except that the initially selected advertisement source would not be included in the selection process at step 1022. For example, the advertisement gateway may determine what other advertisement source has or had an advertisement inventory that is likely to satisfy the requirements of the advertisement request. For example, this determination may be based on records the advertisement gateway may store regarding the inventories of known advertisement sources. As another example, the advertisement gateway may select the next highest priority advertisement source. In some embodiments, the selection of the next advertisement source takes all the parameters into account using weights associated with the profitability of the advertisement source, the size of the inventory in the advertisement source, the type of advertisements in the inventory in the advertisement source, the priority of the advertisement source, or any other suitable parameter of an advertisement source. The advertisement gateway may then select the advertisement source associated with the highest or substantially the highest combined weight value to select the next available source. As noted, these mechanisms may apply to the selection of the initially selected advertisement source.

After making another selection of an advertisement source, process 1000 proceeds back to step 1006 to translate the request into a format that is compatible with the newly selected advertisement source. Process 1000 loops through steps 1006-1022 until either there are no more possible advertisement sources to choose from (in which case a default response is provided), or an advertisement source provides a valid response (e.g., non-empty response). In the latter scenario, the valid response is provided to the user device in a format that is compatible with the user device.

Although the invention has been described with reference to various embodiments illustrated and discussed herein, equivalents may be employed and substitutions made by those skilled in the art herein without departing from the scope of the invention as recited in the claims. For example, it will be appreciated that while the discussion of the present disclosure has focused on selecting an advertisement based on routing rules, the principles of the present disclosure can also be applied to select other types of media content (e.g., programs, movies, music, images, games, etc.) based on any suitable rules.

1. A method for providing advertisements to user devices using an advertisement gateway, the method comprising:
receiving, at the advertisement gateway, an advertisement request for an advertisement from a user device, wherein the advertisement request is in a first format that is compatible with the user device;
translating the advertisement request into a second format that is compatible with an advertisement source;
transmitting the translated advertisement request to the advertisement source;
receiving a response from the advertisement source, wherein the response comprises information regarding an advertisement selected by the advertisement source;
translating the received response into the first format that is compatible with the user device; and
transmitting the translated response to the user device.

2. The method of claim 1, further comprising selecting the advertisement source from a plurality of advertisement sources based on routing rules.

3. The method of claim 2, wherein the routing rules are based at least in part on the inventory characteristics of each advertisement source of the plurality of advertisement sources.

4. The method of claim 2, wherein the routing rules are based at least in part on priority designations associated with the advertisement sources.

5. The method of claim 1, further comprising determining whether the received response is an empty response.

6. The method of claim 5, wherein the empty response does not include advertisement parameters.

7. The method of claim 5, wherein the empty response is a timed out response.

8. The method of claim 5, further comprising determining whether another advertisement source is available in response to determining that the received response is an empty response.

9. The method of claim 8, further comprising selecting another advertisement source if it is determined that the other advertisement source is available.

10. The method of claim 9, further comprising translating the advertisement request into a third format that is compatible with the other advertisement source; and
transmitting the advertisement request in the third format to the other advertisement source.

11. The method of claim 5, further comprising adjusting a weight associated with the advertisement source so that the advertisement source is less likely to be selected to respond to subsequent advertisement requests.

12. The method of claim 5, further comprising transmitting a default response instead of the received response in response to determining that the received response is an empty response.

13. The method of claim 12, wherein the default response comprises default advertisement parameters.

14. The method of claim 1, wherein the first format and the second format are one of Representational State Transfer (REST), Services-Oriented Access Protocol (SOAP), JavaScript Object Notation (JSON), and Extensible Markup Language (XML).

15. The method of claim 14, wherein the first format and the second format are different.

16. A system for providing advertisements to user devices using an advertisement gateway, the system comprising:
control circuitry configured to:
receive, at the advertisement gateway, an advertisement request for an advertisement from a user device, wherein the advertisement request is in a first format that is compatible with the user device;
translate the advertisement request into a second format that is compatible with an advertisement source;
transmit the translated advertisement request to the advertisement source;
receive a response from the advertisement source, wherein the response comprises information regarding an advertisement selected by the advertisement source;
translate the received response into the first format that is compatible with the user device; and
transmit the translated response to the user device.

17. The system of claim 16, wherein the control circuitry is further configured to select the advertisement source from a plurality of advertisement sources based on routing rules.

18. The system of claim 17, wherein the routing rules are based at least in part on the inventory characteristics of each advertisement source of the plurality of advertisement sources.

19. The system of claim 17, wherein the routing rules are based at least in part on priority designations associated with the advertisement sources.

20. The system of claim 16, wherein the control circuitry is further configured to determine whether the received response is an empty response.

21. The system of claim 20, wherein the empty response does not include advertisement parameters.

22. The system of claim 20, wherein the empty response is a timed out response.

23. The system of claim 20, wherein the control circuitry is further configured to determine whether another advertisement source is available in response to determining that the received response is an empty response.

24. The system of claim 23, wherein the control circuitry is further configured to select another advertisement source if it is determined that the other advertisement source is available.

25. The system of claim 24, wherein the control circuitry is further configured to translate the advertisement request into a third format that is compatible with the other advertisement source; and
transmit the advertisement request in the third format to the other advertisement source.

26. The system of claim 20, wherein the control circuitry is further configured to adjust a weight associated with the advertisement source so that the advertisement source is less likely to be selected to respond to subsequent advertisement requests.

27. The system of claim 20, wherein the control circuitry is further configured to transmit a default response instead of the received response in response to determining that the received response is an empty response.

28. The system of claim 27, wherein the default response comprises default advertisement parameters.

29. The system of claim 16, wherein the first format and the second format are one of Representational State Transfer (REST), Services-Oriented Access Protocol (SOAP), JavaScript Object Notation (JSON), and Extensible Markup Language (XML).

30. The system of claim 29, wherein the first format and the second format are different.

31.-45. (canceled)
